(19) United States
(12) Patent Application Publication
(10) Pub. No.: US 2014/0368070 A1
(43) Pub. Date: Dec. 18, 2014

(54) COIL WINDING STRUCTURE OF STATOR CORE

(71) Applicant: SAMSUNG ELECTRO-MECHANICS CO., LTD., Suwon-si (KR)

(72) Inventors: Hyun Kag PARK, Suwon-si (KR); Hae Jun Yang, Suwon-si (KR); Ki Young Lee, Suwon-Si (KR); Jung Kyu Yim, Suwon-si (KR)

(73) Assignee: SAMSUNG ELECTRO-MECHANICS CO., LTD., Suwon-si (KR)

(21) Appl. No.: 14/304,821

(22) Filed: Jun. 13, 2014

(30) Foreign Application Priority Data
Jun. 13, 2013 (KR) 10-2013-0067867

(51) Int. Cl. H02K 3/50

(52) U.S. Cl. CPC H02K 3/50
USPC 310/71

(57) ABSTRACT

Disclosed herein is a coil winding structure of a stator core including: the stator core; an insulator covering the stator core and provided with a coil coupling part; and a coil wound around the stator core and connected to the coil coupling part of the insulator, wherein a solder is injected into the coil coupling part, such that the coil is electrically connected to an external connecting line.

### CROSS REFERENCE TO RELATED APPLICATION

This application claims the benefit of Korean Patent Application No. 10-2013-0067867, filed on Jun. 13, 2013, entitled “Coil Winding Structure of Stator Core”, which is hereby incorporated by reference in its entirety into this application.

### BACKGROUND OF THE INVENTION

1. Technical Field

The present invention relates to a coil winding structure of a stator core.

2. Description of the Related Art

Generally, in a coil wiring or winding structure of a stator core, a coil is wound around the stator core and is electrically connected to an external device through an external connecting terminal.

However, a coil winding structure of a stator core according to the prior art including the following Prior Art Document has problems that it is very complicated to primarily wind a coil around the stator core and electrically connect the coil to a connection pit or a contact pin of an external device, such that productivity is decreased and many defects occur.

### PRIOR ART DOCUMENT

### Patent Document

(Patent Document 1) US 2013-0049742 A

### SUMMARY OF THE INVENTION

The present invention has been made in an effort to provide a coil winding structure of a stator core capable of implementing an automation process and improving productivity due to mass production by a rapid manufacturing process, by forming a coil coupling part at an insulator coupled to the stator core and using a coil coating and solder coupling method.

According to a preferred embodiment of the present invention, there is provided a coil winding structure of a stator core including: the stator core; an insulator covering the stator core and provided with a coil coupling part; and a coil wound around the stator core and connected to the coil coupling part of the insulator, wherein a solder is injected into the coil coupling part, such that the coil is electrically connected to an external connecting line.

The coil coupling part may include: boss parts protruding so that the coil is wound therearound; and a coupling groove into which the external connecting line is inserted.

The boss parts may be configured in pairs formed so as to face each other and have an interval therebetween.

The boss parts may be configured in pairs formed so as to face each other and protruding so as to have an interval therebetween so that the coil is wound therearound, and the coupling groove may be formed between the boss parts configured in pairs so that the external connecting line is inserted thereinto.

The coil may be wound around the boss part, and a partial region of one surface of the coil directed toward the coupling groove may be cut to form a coated part.

The coated part of the coil may be cut and formed by a cutter in a state in which the coil is wound around the boss part.

The coil may be made of an aluminum coil or a copper wire.

The coil winding structure of a stator core as set forth may further include a printed circuit board (PCB) coupling pin inserted into and coupled to the coupling groove.

The PCB coupling pin may be led from a motor controlling circuit.

A wall may be formed by the coil wound around the boss part, and a PCB coupling pin may be inserted into the coupling groove and the solder may be injected into the coupling groove, such that the coil and the PCB coupling pin are electrically connected to each other.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view schematically showing a coil winding structure of a stator core according to a preferred embodiment of the present invention;

FIG. 2 is a perspective view schematically showing an insulator in the coil winding structure of a stator core shown in FIG. 1; and

FIGS. 3A to 3C are use state diagrams schematically showing a process of winding a coil of the stator core shown in FIG. 1.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

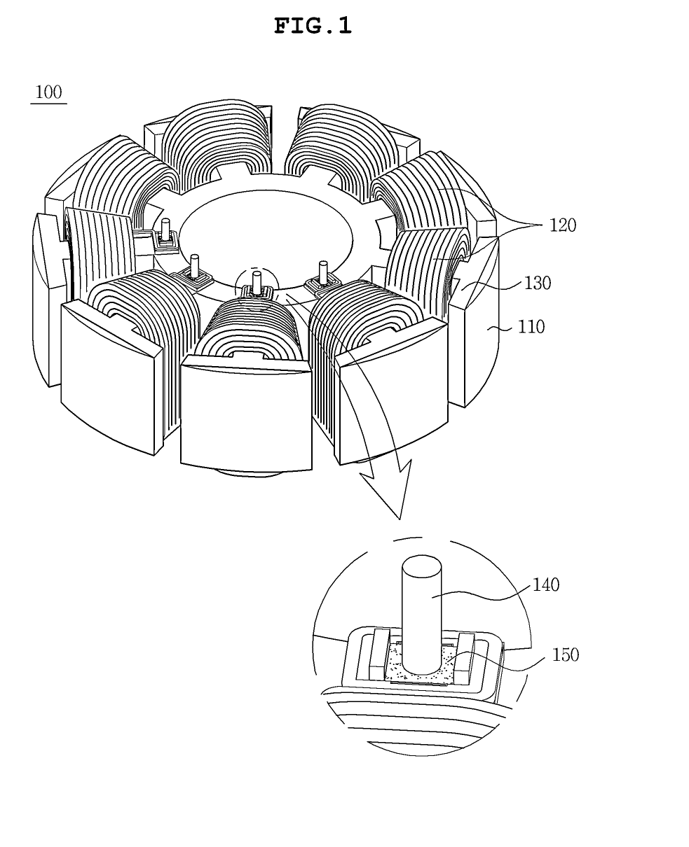

FIG. 1 is a perspective view schematically showing a coil winding structure of a stator core according to a preferred embodiment of the present invention.

As shown in FIG. 1. the coil winding structure 100 of the stator core is configured to include the stator core 110, a coil 120, and an insulator 130, wherein the insulator 130 is provided with a coil coupling part 131 to which the coil 120 is coupled.

In addition, the coil winding structure 100 of the stator core further includes a printed circuit board (PCB) coupling pin 140 coupled to the coil coupling part 131 of the insulator 130. Further, the PCB coupling pin 140, which is led from a motor controlling circuit (not shown), is electrically connected to the coil 120 by a solder 150 injected into the coil coupling part 131, such that the coil is electrically connected to the motor controlling circuit.

To this end, the coil 120 is wound around the coil coupling part 131, and a partial region of the coil directed inwardly of the coil coupling part 131 is coated. That is, the coated region of the coil 120 contacts the solder 150, which contacts the PCB coupling pin 140, such that the coil 120 is electrically connected to the PCB coupling pin 140.

In addition, the coil 120 may be made of an aluminum coil or a copper wire.

Further, the coil winding structure of a stator core according to the preferred embodiment of the present invention may also use an electric wire instead of the PCB coupling pin. That is, coated one end portion of the electrical wire is fixed to the insulator and is electrically connected to the coated region of the coil through the solder.

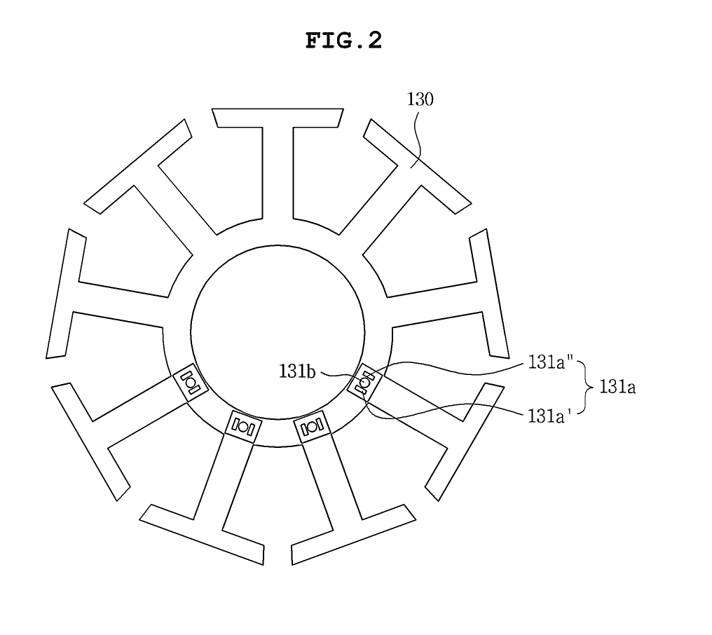

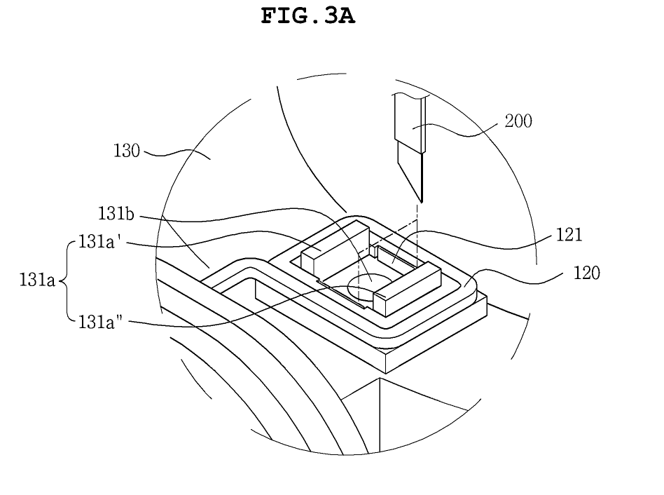

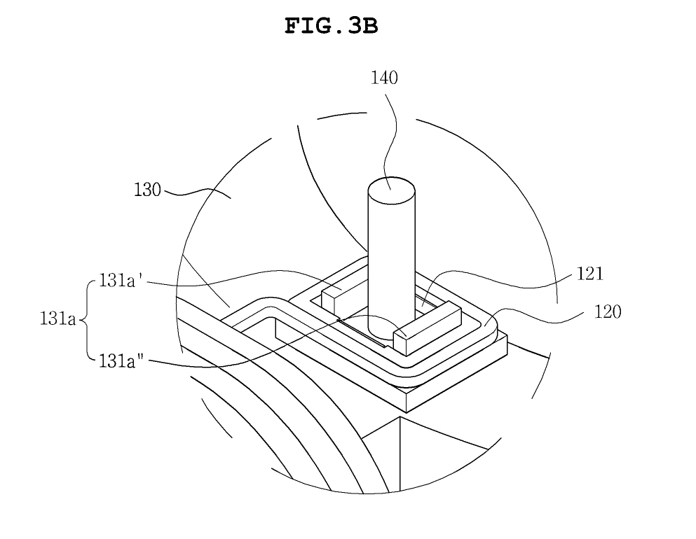

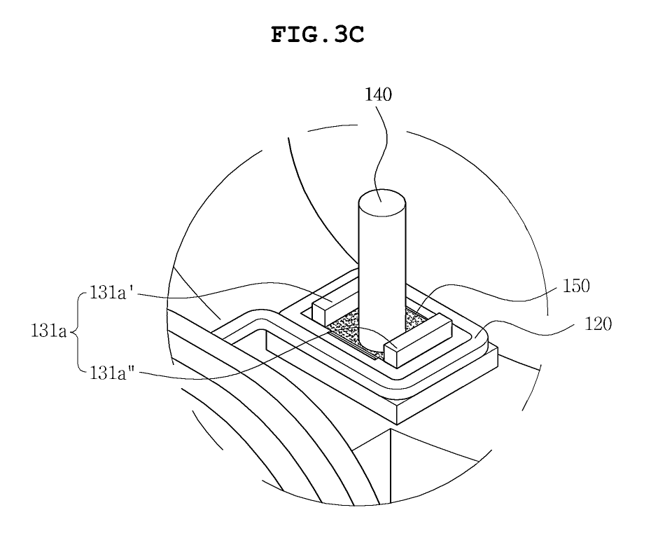

Hereinafter, a configuration, a shape, and organic coupling of the coil winding structure of a stator core will be described in detail with reference to FIGS. 2 and 3.

FIG. 2 is a perspective view schematically showing an insulator in the coil winding structure of a stator core shown in FIG. 1. As shown in FIG. 2, the insulator 130 coupled to the stator core has a shape in which it corresponds to the stator core 110 and covers the stator core 110. In addition, the coil coupling part 131 to which the coil 120 is to be coupled is formed.

Further, a plurality of coil coupling parts 131 may be formed at equal intervals and includes boss parts 131a and a coupling groove 131b.

Here, the boss parts 131 a have a shape in which they protrude so that the coil 120 may be wound therearound and are configured in pairs so as to face each other. That is, in the case in which the coil is wound, the coil is wound around one boss part 131a′ and the other boss part 131a″ while being supported by one boss part 131a′ and the other boss part 131a″.

In addition, the coupling groove 131b into which the PCB coupling pin 140 to be electrically connected to the coil 120 is inserted may be formed between the boss parts 131a′ and 131a″ configured in pairs.

FIGS. 3A to 3C are use state diagrams schematically showing a process of winding a coil of the stator core shown in FIG. 1. As shown in FIG. 3A, the coil 120 is wound around the boss parts 131a′ and 131a″ of the insulator 130. In addition, one surface of the coil directed toward the boss parts 131a′ and 131a″ facing each other is coated.

To this end, one surface of the coil directed inwardly of the boss parts 131a′ and 131a″ is cut using a cutter 200 and is then coated, in a state in which the coil 120 is wound around the boss part 131a′ and 131a″.

Therefore, the coil 120 is provided with a coated part 121.

Next, as shown in FIG. 3B, the PCB coupling pin 140 is inserted into and coupled to the coupling groove 131b (See FIG. 3A) of the insulator 130.

In addition, as shown in FIG. 3C, the solder 150 is injected into the coil coupling part 131 of the insulator 130. That is, in the coil coupling part 131 of the insulator 130, the coil 130 is wound around the boss parts 131a′ and 131a″, such that a wall is formed by the boss parts 131a′ and 131a″ and the coil 120. As a result, even though the solder 150 is injected into the coil coupling part 131, a flow of the solder 150 to the outside is prevented by the wall.

Through the above-mentioned configuration, the coil 120 is electrically connected to the PCB coupling pin 140. To this end, a coil coating and solder coupling method is used, thereby making it possible to implement an automation process and improve productivity due to mass production by a rapid manufacturing process.

According to the preferred embodiment of the present invention, the coil coupling part is formed at the insulator coupled to the stator core and the coil coating and solder coupling method is used, thereby making it possible to obtain a coil winding structure of a stator core capable of implementing an automation process and improving productivity due to mass production by a rapid manufacturing process.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A coil winding structure of a stator core comprising:
the stator core;
an insulator covering the stator core and provided with a coil coupling part; and
a coil wound around the stator core and connected to the coil coupling part of the insulator,
wherein a solder is injected into the coil coupling part, such that the coil is electrically connected to an external connecting line.

2. The coil winding structure of a stator core as set forth in claim 1, wherein the coil coupling part includes:
boss parts protruding so that the coil is wound therearound; and
a coupling groove into which the external connecting line is inserted.

3. The coil winding structure of a stator core as set forth in claim 2, wherein the boss parts are configured in pairs formed so as to face each other and have an interval therebetween.

4. The coil winding structure of a stator core as set forth in claim 2, wherein the boss parts are configured in pairs formed so as to face each other and protruding so as to have an interval therebetween so that the coil is wound therearound, and
the coupling groove is formed between the boss parts configured in pairs so that the external connecting line is inserted thereinto.

5. The coil winding structure of a stator core as set forth in claim 4, wherein the coil is wound around the boss part, and a partial region of one surface of the coil directed toward the coupling groove is cut to form a coated part.

6. The coil winding structure of a stator core as set forth in claim 5, wherein the coated part of the coil is cut and formed by a cutter in a state in which the coil is wound around the boss part.

7. The coil winding structure of a stator core as set forth in claim 5, wherein the coil is made of an aluminum coil or a copper wire.

8. The coil winding structure of a stator core as set forth in claim 5, further comprising a printed circuit board (PCB) coupling pin inserted into and coupled to the coupling groove.

9. The coil winding structure of a stator core as set forth in claim 5, wherein the PCB coupling pin is led from a motor controlling circuit.

10. The coil winding structure of a stator core as set forth in claim 5, wherein a wall is formed by the coil wound around the boss part, and
a PCB coupling pin is inserted into the coupling groove and the solder is injected into the coupling groove, such that the coil and the PCB coupling pin are electrically connected to each other.
